(19) United States
(12) Patent Application Publication
(10) Pub. No.: US 2017/0024380 A1
(43) Pub. Date: Jan. 26, 2017

(54) SYSTEM AND METHOD FOR THE TRANSLATION OF SIGN LANGUAGES INTO SYNTHETIC VOICES

(71) Applicant: MAP CARDOSO, Manaus (BR)

(72) Inventor: Manuel Augusto Pinto Cardoso, Manaus (BR)

(73) Assignee: MAP CARDOSO, Manaus (BR)

(21) Appl. No.: 15/159,232

(22) Filed: May 19, 2016

(30) Foreign Application Priority Data
Jul. 23, 2015 (BR) 1020150176686

(51) Int. Cl. G06F 17/28; G06F 17/27; G09B 5/02; G06N 3/08; G09B 21/00; G10L 13/027; G06F 3/01

(52) U.S. Cl. CPC G06F 17/2836; G10L 13/027; G06F 17/2705; G06F 3/014; G06N 3/08; G09B 21/009; G09B 5/02

(57) ABSTRACT

A system and method for the translation of sign languages into synthetic voices. The present invention refers to the field of assistive technologies, and comprises an instantaneous communication system between hearing- and speech-impaired individuals with hearing-able individuals. More specifically, the invention relates to a method for translating, in real time, the sign language of one individual into oral language by employing biometric sensors, wireless data communication, and a built-in software in a cellphone or another compatible mobile computing device. In certain exemplar embodiments, the invention facilitates associating the recognition of movements and gestures to letters, words, and sentences, and synthesizing the same into an electronic voice.

### STATEMENT OF RELATED APPLICATIONS

This patent application claims priority on and the benefit of Brazilian Patent Application No. 10 2015 017 668 6 having a filing date of 23 Jul. 2015

### BACKGROUND OF THE INVENTION

### Technical Field

The present invention belongs to the field of assistive technologies and refers to a system for instantaneous communication between the hearing-impaired and speech-impaired individuals with hearing-able persons. In certain exemplary embodiments, the present invention refers to a system for real-time translation of the sign language into speech, employing biometric sensors, wireless communication, and a smartphone or another mobile computing device. In certain exemplary embodiments, the system for real-time translation associates the recognition of movements and gestures to letters, words, and sentences, and synthesizes the same in an electronic voice.

### Prior Art

There are no great difficulties in the communication between individuals that do not hear and/or do not speak, however it is known that there is a great limitation when the relationship occurs with persons unable to understand the sign language because in general they are able to perceive what we say by reading our lips, but we are unable to understand their gestures and signs. To minimize this problem, there are found those persons that hear and speak and also understand the sign language, who serve as interpreters, and there are also some devices capable of providing the said translation to the remaining individuals.

Although such options are available, there is not currently available a means that is simple, accessible, efficient and portable to overcome such difficulty and improve the social interaction of that group of persons.

There are already known methods, systems and devices to facilitate such communication, as may be noted in the solutions found and described below.

Patent application No. MU 8902426-5, presents a device for translating speech signals, comprising a camera that captures the movements and gestures of the hand of the user. The device converts the same into sound using the controller and transmits that sound through a loudspeaker, wherein that sound represents the human speech, such that the individual that does not understand the sign language may understand the sound emitted by the loudspeaker and may interpret the message of the user.

Another technical solution presented in patent application No. PI 0510899-3 describes a communication system that allows the simultaneous, automatic, and customizable translation of the gestural repertoire into verbal language. This is a computerized communication system that allows any person to communicate with others by way of signals that are automatically translated into verbal language. Its working principle is based on the placement of accelerometers on the fingers and the hands. They may also be placed in the perilabial region and also implanted in the tongue. Accelerometers are capable of supplying signals that inform position and movement. With those devices, a repertoire of gestures and signals can be converted to equivalents based on verbal language. They also allow their users to communicate without knowledge of the standard sign language, based on a gestural repertoire created and executed according to the user's individual preferences and needs. In addition to allowing the communication between individuals that are impaired in their speech or hearing, the system further allows any person to communicate in a foreign language, even without knowing the grammar or any vocabulary.

Another technical solution presented in patent application No. PI 9706005-4 describes a portable device named Communicator with voice and language translator by a speaker means, which allows the speech-impaired (mute) to communicate by voice, instantly, with other people, as well as with a non-impaired individual. Communicator provides speaker-aided language translations instantly, to communicate with persons that know a different language, thereby providing immediate speakerphone communication in the everyday life. Communicator comprises a mini-keypad attached to the upper arm of the user with the mini-keypad being provided with a conventional electronic system to send keyed-in signals by means of carrier waves to the computer. The computer is provided with a specific conventional software for receiving keypad signals and converting the same conventionally into sound signals of human speech. The computer then returns, via the means of carrier waves, the conversion product to the micro-speaker receiver functionally attached to the individual user.

Another technical solution presented in patent application No. PI 1000633-8 describes an Automatic Bidirectional Translating System between signal language and oral-aural languages. The Automatic Bidirectional Translating System constitutes a communication system (MSign) for integral and effective communication between the hearing impaired/deaf and listeners. The Automatic Bidirectional Translating System involves automatic and bidirectional intermodal-interlanguage translation using a cellphone/smartphone, tablet, PC, or mobile device. The Automatic Bidirectional Translating System employs a means of communication, for example, a cellphone/smartphone capable of wirelessly receiving the data relative to the signs of the sign language of the hearing impaired/deaf. The Automatic Bidirectional Translating System obtains the signs of the sign language of the hearing impaired/deaf by means of sensors located on the hands and on the body of the hearing impaired/deaf person, for example, a data glove translating the same into text/speech in the language of the listening individual with whom conversation is attempted.

### BRIEF SUMMARY OF THE INVENTION

Based on what has been set forth, in certain exemplary embodiments, it is an objective of the present invention to provide an efficient mechanism to allow the speech- and hearing-impaired individuals to overcome the difficulties in communication, by means of a translator of movements and gestures into instantaneous electronic voice, using their own cellphone or other mobile computing device. This solution is based on the integration of the mobile technology of the cellphones, state-of-the-art biometric sensors applied in games, and the application of artificial intelligence (comprising mathematical algorithms named Artificial Neural Networks and Fuzzy Logic). In certain exemplary embodiments, the artificial intelligence of this solution models a behavior similar to that of the biological neurons and learns to recognize signal patterns, that in the present case are the movements of the upper arm, of the hand, and of the fingers and commands of electronic voice synthesis.

Furthermore, in certain exemplary embodiments, it is an objective of the present invention to provide a system consisting of sensors that characterize the space movement of the arm, hands, and fingers included in gloves, bracelets, and similar devices. The system may be related to movements connected to standardized sign language used by people with hearing loss; these movements are recognized by a data processing program embedded in mobile or fixed electronic devices, such as tablets, smartphones, and computers. In certain exemplary embodiments, the movement recognized by the embedded program will relate with a translation to a spoken language that has been configured in the program. Said movement that was translated by the program to a spoken language may be synthesized into electronic voice by the device on which the program is embedded.

More specifically, in certain exemplary embodiments, an electromyographic sensor attached to a bracelet is positioned on the forearm, below the elbow of the user, to capture the biological signals and transmits the same in the form of wireless data, using the Bluetooth technology, for example, to a cellphone or another mobile device. The cellphone or other mobile device, which carries a specific software with a mathematical algorithm representative of an artificial neural network capable of learning, recognizing, and classify the signals received from the sensor, associates the transmitted biological signals with the movements and gestures performed by the arm, hand, or fingers. These movements are in turn associated with letters, words, commands, and preprogrammed sentences that are modifiable by the user, which are then synthesized into an electronic voice by the mobile device.

Furthermore, in certain exemplary embodiments, the object of the present patent application is characterized a system that involves a software based on Neural networks and Fuzzy logic combined with a method that associates the recognition of movements and gestures with letters, words and sentences that are instantaneously synthesized into an electronic voice by a mobile computing device. The Neural networks and Fuzzy logic are processed in the mobile computing device, for recognition of patterns of signals generated by biometric sensors of the muscles responsible by the movement of the human arm, hand, and fingers. Proceeding from here, the object underlying the invention is to propose a method and a device for higher performance.

### BRIEF DESCRIPTION OF THE DRAWINGS

The present invention will be better understood from the detailed description that follows and the figures that refer thereto:

FIG. 1 is a functional diagram of one exemplary embodiment of the invention; and

FIG. 2 is a flow diagram of the operation of one exemplary embodiment of a System of the invention.

### DETAILED DESCRIPTION OF PREFERRED EMBODIMENTS

In certain exemplary embodiments, the present invention refers to a system for instantaneous communication between the hearing-impaired and speech-impaired individuals with hearing-able persons. Moreover, in certain exemplary embodiments, the present invention refers to a system for real-time translation of the sign language into speech, employing biometric sensors, wireless communication, and a smartphone or another mobile computing device. Moreover, in certain exemplary embodiments, the system for real-time translation associates the recognition of movements and gestures to letters, words, and sentences, and synthesizes the same in an electronic voice.

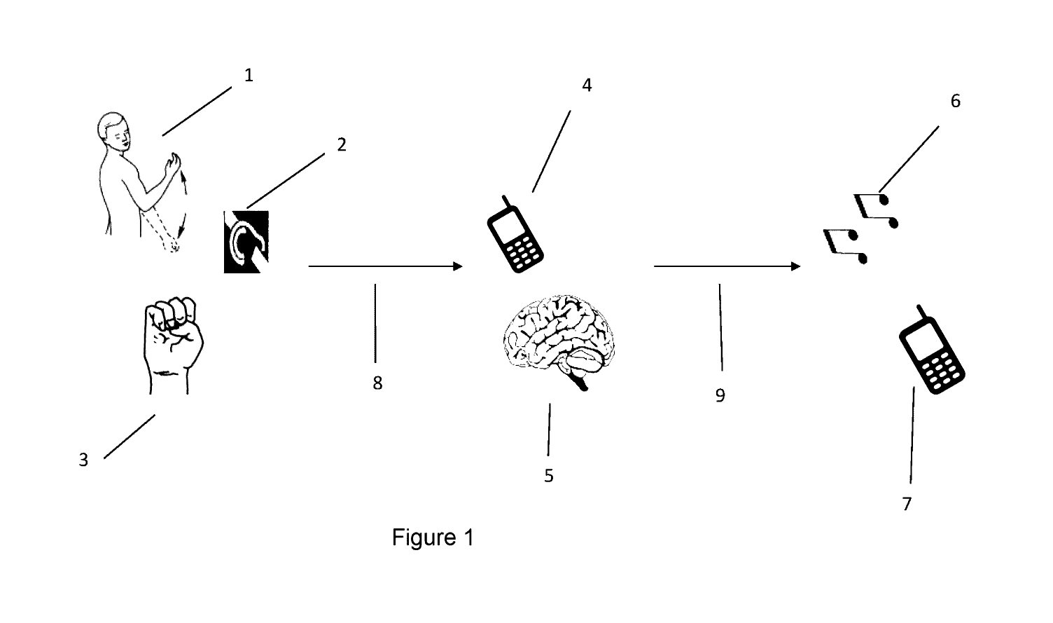

Reference is now made to FIG. 1. Based on the movements of the hearing-impaired user, using a bracelet containing a sensor of the Myo type 1-1 and 1-2, or based on the gestures in Libra or sign language 1-3, a signal is sent via Bluetooth 1-8 to a cellular apparatus or other mobile device 1-4 equipped with a specific software that processes the artificial intelligence 1-5, which translates the received signal into a synthetic voice 1-6, using a transition between the output of the artificial intelligence and the API—Application Program Interface of voice 1-9.

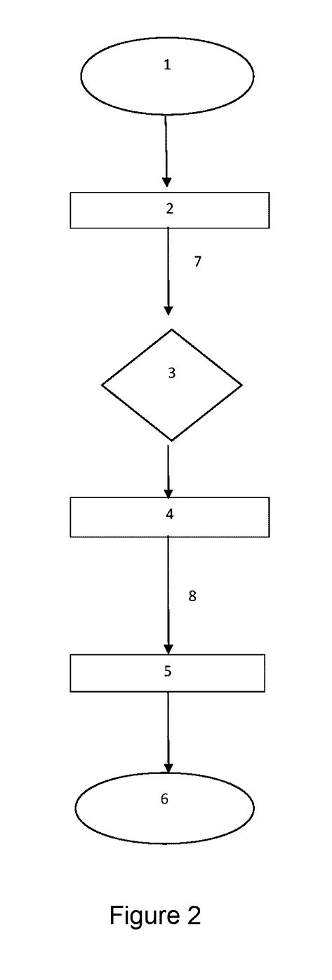

With reference to FIG. 2, it may be noted that the flow of the process is initiated when the hearing-impaired user 2-1, who is wearing the bracelet with the Myo sensor, moves his or her forearm or gestures with the hand or with the fingers 2-2. The flow of the process continues with transmission of the sensor data/signal, via Bluetooth 2-7, to a cellphone or another mobile device 2-3, which hosts the artificial intelligence 2-4. The flow of the process continues with the artificial intelligence 2-4, which performs the processing of the received signals, passing through a transition 2-8 between the output of the artificial intelligence and the API—Application Program Interface of voice 2-5, and finishes with the reproduction of the electronic voice by means of the cellphone or mobile device 2-6.

What is claimed is:

1. A method for the instantaneous communication between hearing-/speech-impaired individuals with hearing-able individuals employing real-time translation of sign languages into synthetic voices, comprising:
a) providing a biometric sensor on the forearm, below the elbow, of a hearing- or speech-impaired individual, the biometric sensor configured to detect a biological signal representative of a movement and gesture performed by the arm, the hand, or the fingers of the hearing- or speech-impaired individual, the biometric sensor communicatively coupled to a mobile computing device running built-in software;
b) receiving and capturing the biological signal, via a wireless data communication, at the mobile computing device;
c) processing, via the built-in software, the biological signal to ascertain the movement and gesture performed by the arm, the hand, or the fingers of the hearing- or speech-impaired individual;
d) associating, via the built-in software, the ascertained movement and gesture with a letter, word, clause, or sentence; and
e) synthesizing, by the mobile computing device, the associated letter, word, clause, or sentence into an electronic voice;
wherein the built-in software running on the mobile computing device is a specific mathematical algorithm representative of an artificial neural network, and is configured to learn, recognize, and classify the biological signals received from the biometric sensor; and
wherein associating the ascertained movement and gesture involves a set of preprogrammed letters, words, clauses, or sentences that are modifiable by the hearing- or speech-impaired individual.

2. The method of claim 1, wherein the act of providing a biometric sensor on the forearm, below the elbow, of a hearing- or speech-impaired individual comprises providing a Myo sensor on the forearm.

3. The method of claim 1, wherein the act of providing a biometric sensor on the forearm, below the elbow, of a hearing- or speech-impaired individual comprises providing a Myo sensor attached to a bracelet on the forearm.

4. The method of claim 1, wherein the act of receiving and capturing the biological signal, via a wireless data communication, at the mobile computing device comprises receiving and capturing the biological signal via a Bluetooth technology.

5. A system for the instantaneous communication between hearing-/speech-impaired individuals with hearing-able individuals employing real-time translation of sign language into synthetic voices, comprising:
a) a mobile computing device running built-in software capable of leveraging, at least in part, a specific mathematical algorithm that provides an artificial neural network configured to learn, recognize, and classify a biological signal;
b) a biometric sensor for placement on the forearm, below the elbow, of a hearing- or speech-impaired individual, the biometric sensor configured to detect the biological signal relevant to the built-in software of the mobile computing device;
c) 0a wireless data communication component configured to transmit the biological signal detected by the biometric sensor to the artificial neural network of the mobile computing device; and
d) an electronic vocalization component configured to synthesize, into an electronic voice, a letter, word, clause, or sentence representative of a movement and gesture performed by the arm, the hand, or the fingers of the hearing- or speech-impaired individual;
wherein the artificial neural network being configured to learn, recognize, and classify the biological signal involves:
processing the biological signal to ascertain the movement and gesture performed by the arm, the hand, or the fingers of the hearing- or speech-impaired individual; and
associating the ascertained movement and gesture with a set of preprogrammed letters, words, clauses, or sentences that are modifiable by the hearing- or speech-impaired individual.

6. The system of claim 5, wherein the biometric sensor for placement on the forearm, below the elbow, of a hearing- or speech-impaired individual comprises a Myo sensor.

7. The system of claim 5, wherein the biometric sensor for placement on the forearm, below the elbow, of a hearing- or speech-impaired individual comprises a Myo sensor integral to a bracelet.

8. The system of claim 5, wherein the wireless data communication component comprises Bluetooth technology.

9. A method for the instantaneous communication between hearing-/speech-impaired individuals with hearing-able individuals employing real-time translation of sign languages into synthetic voices, comprising:
a) providing a Myo type biometric sensor on the body of a hearing- or speech-impaired individual, the biometric sensor configured to detect a sequence of movements and gestures associated with Libra or other sign languages, the Myo type biometric sensor communicatively coupled to a mobile computing device running built-in software;
b) receiving and capturing the detected sequence of movements and gestures, via a wireless data communication, at the mobile computing device;
c) parsing, via the built-in software, the detected sequence of movements and gestures to ascertain the component movements and gestures associated with Libra or other sign languages;
d) associating, via the built-in software, the ascertained component movements and gestures with a letter, word, clause, or sentence; and
e) synthesizing, by the mobile computing device, the associated letter, word, clause, or sentence into an electronic voice;
wherein the built-in software running on the mobile computing device is an artificial intelligence involving a Neural network, a Fuzzy logic, and an Application Program Interface of voice, and is configured to learn, recognize, and classify the ascertained component movements and gestures derived from the Myo type biometric sensor.

10. The method of claim 9, wherein the act of providing a Myo type biometric sensor on the body of a hearing- or speech-impaired individual comprises providing a Myo sensor attached to a bracelet.

11. The method of claim 9, wherein the act of receiving and capturing the detected sequence of movements and gestures, via a wireless data communication, at the mobile computing device comprises receiving and capturing the biological signal via a Bluetooth technology.

12. A system for the instantaneous communication between hearing-/speech-impaired individuals with hearing-able individuals employing real-time translation of sign language into synthetic voices, comprising:
a) a mobile computing device running built-in software capable of leveraging, at least in part, a Neural network, a Fuzzy logic, and a Application Program Interface of voice, the mobile computing device operating, at least in part, as an artificial intelligence configured to learn, recognize, and classify movements and gestures associated with Libra or other sign languages;
b) a Myo type biometric sensor for placement on the body of a hearing- or speech-impaired individual, the Myo type biometric sensor configured to detect a sequence of movements and gestures performed by the hearing- or speech-impaired individual;
c) a wireless data communication component configured to transmit the detected sequence of movements and gestures to the artificial intelligence of the mobile computing device; and
d) an electronic vocalization component configured to synthesize, into an electronic voice, a letter, word, clause, or sentence representative of the detected sequence of movements and gestures performed by the hearing- or speech-impaired individual;
wherein the artificial intelligence being configured to learn, recognize, and classify movements and gestures associated with Libra or other sign languages involves:
parsing the detected sequence of movements and gestures, performed by the hearing- or speech-impaired individual, to ascertain the component movements and gestures associated with Libra or other sign languages; and
associating the ascertained component movements and gestures with a set of letters, words, clauses, or sentences accessible to the mobile computing device.

13. The system of claim 12, wherein the Myo type biometric sensor for placement on the body of a hearing- or speech-impaired individual is integral to a bracelet for placement on the body of a hearing- or speech-impaired individual.

14. The system of claim 12, wherein the wireless data communication component comprises Bluetooth technology.
